(19) United States
(12) Patent Application Publication
(10) Pub. No.: US 2015/0185524 A1
(43) Pub. Date: Jul. 2, 2015

(54) Touch-screen Display Device

(71) Applicant: Shenzhen China Star Optoelectronics Technology Co., Ltd., Shenzhen, Guangdong (CN)

(72) Inventors: Chengliang Ye, Shenzhen (CN); Chunkai Chang, Shenzhen (CN); Ruhai Fu, Shenzhen (CN); Jie Qiu, Shenzhen (CN); Yung-lun Lin, Shenzhen (CN)

(73) Assignee: Shenzhen China Star Optoelectronics Technology Co., Ltd., Shenzhen, Guangdong (CN)

(21) Appl. No.: 14/235,082

(22) PCT Filed: Jan. 9, 2014
(86) PCT No.: PCT/CN2014/070371

§ 371 Date: Jan. 27, 2014

(30) Foreign Application Priority Data
Dec. 30, 2013 (CN) 201310745617.1

(51) Int. Cl. G02F 1/1333; G02F 1/1335

(52) U.S. Cl. CPC G02F 1/13338; G02F 1/133528

(57) ABSTRACT

The present invention provides a touch-screen display device, which includes a liquid crystal display module, a first polarized film, a first sensor, wherein the first polarized film is disposed onto the liquid crystal display module, and the first sensor is dielectrically disposed onto the first polarized film. Wherein the liquid crystal display module includes a common electrode, a backlight module, a thin film transistor array substrate, a liquid crystal layer, and a color filter substrate, wherein the color filter is disposed onto the backlight module, and the thin film transistor array substrate is disposed under the first polarized film and above the color film substrate, the liquid crystal layer being arranged between the thin film transistor array substrate and the color filter substrate, and the common electrode being arranged between the liquid crystal layer and the thin film transistor array substrate. With the provision of the present invention, the present invention can reduce the thickness of the touch-screen display device as well as reducing the manufacturing cost.

### CROSS REFERENCE

This application also related to National Stage Application No. ______ (Attorney Docket No. CM14009), submitted on the same date, entitled, “Touch-Screen Display Device” assigned to the same assignee.

### FIELD OF THE INVENTION

The present invention relates to a display device, and more particularly, to a touch-screen display device.

### DESCRIPTION OF PRIOR ART

Touch-screen display device is a display device incorporated with a touch-sensing panel such that the display panel can provide an interactive operation through touching movement detectable by the touch-screen panel. Currently, touch-screen display device made form liquid crystal display is the most popular to the customer. According to its configuration, the touch-screen display panel can be categorized into resistive type, capacitive, surface acoustic, and touch styles. Among those four types, the capacitive type is most popular since it requires no pressure to generate signals. In addition, after the production, there is no need of calibration or only need to perform once. It features prolong service life. Accordingly, it has been developed quickly in recently year.

FIG. 1 is a configurational and illustrational view of a prior art capacitive touch-screen display panel. Referring to FIG. 1, the capacitive touch-screen display panel of prior art includes a touch-screen panel 1, and a liquid crystal display module 2 located under the touch-screen panel 1.

The touch-screen panel 1 includes a protective glass 11, a first sensor 12, a first sensor substrate 13, a second sensor 14, and a second sensor substrate 15. The first sensor 12 (for example, an indium tin oxides, ITO), the second sensor substrate 13 (for example, polyethylene terephthalate, PET), the first sensor 14 (for example, an ITO), and the second sensor substrate 15 (for example, a PET)are disposed and arranged under the touch-screen panel 1. In the current technology, in order to deposit the first and second sensors 12, 14, the first and second sensor substrates 13 and 15 have to be disposed firstly. Not only will this cause additional manufacturing cost, but will also increase the thickness of the touch-screen display device.

### SUMMARY OF THE INVENTION

In order to resolve the technical problem encountered by the prior art, the present invention provides a touch-screen display device, including a liquid crystal display module, a first polarized film, a first sensor and a second sensor, wherein the first polarized film is disposed onto the liquid crystal display module, and the second polarized sensor is disposed onto the first polarized film, wherein the first sensor is dielectrically disposed onto the second sensor.

Further, wherein the first sensor is a touch-sensing electrode, and the second sensor is touch sensing driving electrode.

Wherein further includes an insulative layer arranged between the first sensor and a second sensor.

Wherein further includes a protective plate disposed onto the first sensor.

Further includes flexible printed circuit board having one end interconnected to a motherboard, and having a dual-connection arrangement on the other end, wherein one of the dual-connection arrangement is interconnected to the first sensor, and the other of the dual-connection arrangement is connected to the second sensor.

According to another object of the present invention, a touch-screen display device is provided and it includes a liquid crystal display module, a first polarized film, a first sensor, wherein the first polarized film is disposed onto the liquid crystal display module, and the first sensor is dielectrically disposed onto the first polarized film.

Wherein the liquid crystal display module further includes a common electrode, a backlight module, a thin film transistor array substrate, a liquid crystal layer, and a color filter substrate, wherein the color filter is disposed onto the backlight module, and the thin film transistor array substrate is disposed under the first polarized film and above the color film substrate, the liquid crystal layer being arranged between the thin film transistor array substrate and the color filter substrate, and the common electrode being arranged between the liquid crystal layer and the thin film transistor array substrate.

Wherein the common electrode is served as a displaying circuit for operation during the display stage when an image is displayed onto the touch-screen display device, and wherein the common electrode is served as a touch-sensing operational circuit during the touch-sensing stage.

Wherein further includes a protective plate which is disposed onto the first sensor.

Further includes flexible printed circuit board having one end interconnected to a motherboard, and having a dual-connection arrangement on the other end, wherein one of the dual-connection arrangement is interconnected to the first sensor, and the other of the dual-connection arrangement is connected to the second sensor.

The touch-screen display device made in accordance with the present invention uses a polarized film of a liquid crystal display module as a deposit substrate of a sensor so as to reduce a thickness of the touch-screen device as well as the manufacturing cost.

### BRIEF DESCRIPTION OF DRAWINGS

FIG. 1 is a configurational and illustrational view of a prior art capacitive touch-screen display panel;

FIG. 2 is a configurational and illustrational view of a touch-screen display panel made in accordance with a first embodiment of the present invention; and

FIG. 3 a configurational and illustrational view of a touch-screen display panel made in accordance with a second embodiment of the present invention.

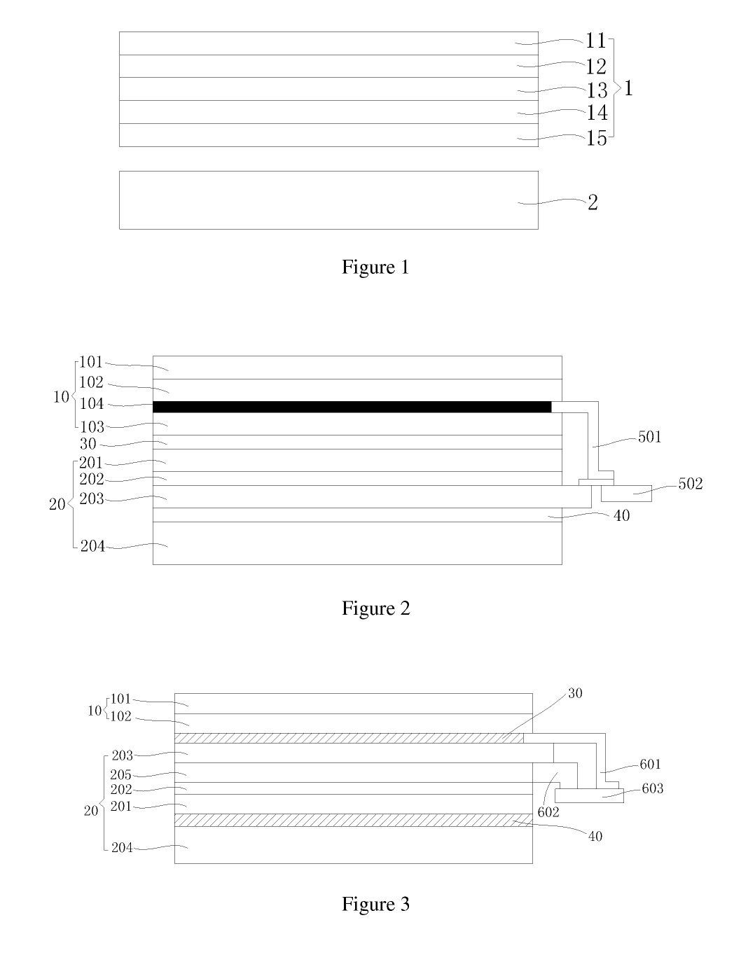

### DETAILED DESCRIPTION OF PREFERRED EMBODIMENTS

Detailed description will be given to the illustrational embodiments of the present invention along with the accompanied drawings in which the embodiments are shown. However, it should be noted that many different embodiments can be implemented, and the present invention should not be construed as being limited to the embodiments only. To the contrary, by the illustration of the preferred embodiments in full and complete manner, the spirit and scope of the present invention can be completely conveyed to the skilled in the art. In the accompanied drawings, same numeral reference will be used to represent the same element through out the specification.

FIG. 2 is a configurational and illustrational view of a touch-screen display panel made in accordance with a first embodiment of the present invention.

Referring to FIG. 2, the touch-screen display panel made in accordance with a first embodiment of the present invention includes a touch-screen panel 10, a liquid crystal display module 20, a first polarized film 30, and a second polarized film 40.

According to the first embodiment of the present invention, the touch-screen panel 10 includes a protective plate 101, a first sensor 102 and a second sensor 103. The protective plate 101 can be implemented as a protective glass substrate, and is arranged on top of the touch-screen panel 10 to protect the first sensor 102. The first sensor 102 is arranged under the protective plate 101. The second sensor 103 is disposed under the first sensor 102, and the first sensor 102 and the second sensor 103 are dielectrically arranged with each other. In the current embodiment, the touch-screen panel 10 further includes an insulative layer 104, which is made from SiNx, SiOx or the combination thereof. The insulative layer 104 is arranged between the first sensor 102 and the second sensor 103 so as to dielectrically separate each other. However, the present invention will not be limited thereto, for example, the first sensor 102 and the second sensor 103 can be bonded together with adhesive layer along their sides. That is to say the adhesive layer is arranged to surround the first sensor 102 and the second sensor 103 such that the first and second sensors 102, 103 are dielectrically separated from one another.

In addition, in the current embodiment, the first sensor 102 can be served as a touch-sensing electrode to detect the touching movement of a user, and it can be made from metal from an alloy configured with copper, niobium, chrome, or an alloy configured from silver, platinum, and copper, or molybdenum, aluminum, or indium tin oxide ITO), etc. The second sensor 103 can be served as a touch-sensing driving electrode to trigger a working command corresponding to the finger movement of the user performed on the first sensor 102. It can be made from metal from an alloy configured with copper, niobium, chrome, or an alloy configured from silver, platinum, and copper, or molybdenum, aluminum, or indium tin oxide ITO), etc. This present invention should not be limited thereto.

The liquid crystal display module 20 made in accordance with a first embodiment of the present invention includes a color filter substrate 201, a liquid crystal layer 202, a thin film transistor array substrate 203, and a backlight module 204. The color filter substrate 201 can also be referred to as CF, and it generally includes a transparent substrate, such as a glass substrate, and black patterns or images arranged on the transparent substrate, color photo-resistors, such as R, G and B filter film with patterns or images, and an alignment layer. The liquid crystal layer 202 is disposed between the color filter substrate 201 and the thin film transistor array substrate 203. The color filter substrate 201 is arranged with respect to the thin film transistor array substrate 203, which is also referred to as TFT substrate which generally includes a transparent substrate (such as a glass substrate), and a plurality of thin film transistors arranged in array. The backlight module 204 is disposed under the thin film transistor array substrate 203 for mainly providing light source. The thin film transistor array substrate 203 provides driving voltage to the liquid crystal molecules in the liquid crystal layer 202 so as to align the liquid crystal molecules in a way that the light beam from the backlight module 204 can pass through the liquid crystal layer 202. As a result, images or patterns can be displayed onto the liquid crystal display module 20 with the corporation of the color filter substrate 201.

In the current embodiment, the second polarized film 40 is arranged between the thin film transistor array substrate 203 and the backlight module 204. The first polarized film is arranged between the color filter substrate 201 and the second sensor 103 so as to make the first polarized film 30 to serve as a deposit substrate of the first sensor 102 and the second sensor 103. By this arrangement, the deposit substrate originally needed for the first sensor 102 and the second sensor 103 can be saved. Not only this arrangement will reduce the overall thickness of the touch-screen display device, but also will reduce the manufacturing cost thereof.

It should be pointed out that according to the first embodiment of the present invention, the touch-screen display device further includes a flexible printed circuit board 501 which has one end interconnected to a motherboard 502 for getting power supply, and having a dual-connection arrangement on the other end. Wherein one of the dual-connection arrangements is interconnected to the first sensor 102, and the other of the dual-connection arrangement is connected to the second sensor 103. In addition, the motherboard 502 is further interconnected to a driving chip (not shown in the drawings) arranged within the thin film transistor array substrate 203 of the liquid crystal display module 20 to as to provide driving voltage to the liquid crystal display module 20.

In addition, in assembling, the touch-screen panel 10 and the liquid crystal display module 20 can be configured together with an adhesive layer (not shown in Figures). However, the present invention will not be limited thereto.

FIG. 3 a configurational and illustrational view of a touch-screen display panel made in accordance with a second embodiment of the present invention.

Referring to FIG. 3, the touch-screen display panel made in accordance with a second embodiment of the present invention includes a touch-screen panel 10, a liquid crystal display module 20, a first polarized film 30, and a second polarized film 40.

According to the second embodiment of the present invention, the touch-screen panel 10 includes a protective plate 101, and a first sensor 102. The protective plate 101 can be implemented as a protective glass substrate, and is arranged on top of the touch-screen panel 10 to protect the first sensor 102. The first sensor 102 is arranged under the protective plate 101. The first sensor 102 is disposed under the protective plate 101 and above the liquid crystal display module 20. In other world, the first sensor 102 is directly deposited onto the first polarized film 30.

In addition, in the current embodiment, the first sensor 102 can be served as a touch-sensing electrode to detect the touching movement of a user, and it can be made from metal from an alloy configured with copper, niobium, chrome, or an alloy configured from silver, platinum, and copper, or molybdenum, aluminum, or indium tin oxide ITO), etc. However, the present invention should not be limited thereto.

The liquid crystal display module 20 made in accordance with a second embodiment of the present invention includes a color filter substrate 201, a liquid crystal layer 202, a thin film transistor array substrate 203, a backlight module 204, and a common electrode 205. The color filter substrate 201 can also be referred to as CF, and it generally includes a transparent substrate, such as a glass substrate, and black patterns or images arranged on the transparent substrate, a color photo-resistors layer, such as R, G and B filter film with patterns or images, and an alignment layer. The thin film transistor array substrate 203, which is arranged onto the color filter substrate 201 is also referred to as TFT substrate, and which generally includes a transparent substrate (such as a glass substrate), and a plurality of thin film transistors arranged in array. The liquid crystal layer 202 is disposed between the color filter substrate 201 and the thin film transistor array substrate 203. The common electrode 205 is disposed between the liquid crystal layer 202 and the thin film transistor array substrate 203, and it can be made from indium tin oxide (ITO) or others. The backlight module 204 is disposed under the color filter substrate 201 for mainly providing light source. The thin film transistor array substrate 203 provides driving voltage to the liquid crystal molecules in the liquid crystal layer 202 so as to align the liquid crystal molecules in a way that the light beam from the backlight module 204 can pass through the liquid crystal layer 202. As a result, images or patterns can be displayed onto the liquid crystal display module 20 with the corporation of the color filter substrate 201.

In the current embodiment, when the liquid crystal display displays an image, there is a window period, i.e. after a completion of scanning of the image through gate lines, there is a window period. Only after the blank time runs out, the scanning of the second image starts. Accordingly, during that window period, the screen can support a touch-screen operation.

During an image displaying stage, the common electrode 205 will be served as a display circuit operation of the touch-screen display module 20 along with other display pixels so as to have the liquid crystal display module 20 to display images or patterns. And during the touch-sensing stage, in order to fulfill the touch-sensing operation of the touch-screen display device made in accordance with the present invention, the common electrode 205 of the touch-screen display panel 20 can be used as a touch-sensing driving electrode, and the first sensor 102 is used as the touch-sensing electrode. As a result, when the first sensor 102 detects the movement of the finger or other, the common electrode 205 will trigger a corresponding command corresponding to signal from the first sensor 120.

In the current embodiment, the second polarized film 40 is arranged between the color filter substrate 201 and the backlight module 204. The first polarized film 30 is arranged between the first sensor 102 and the thin film transistor array substrate 203, so as to make the first polarized film 30 to serve as a deposit substrate of the first sensor 102. By this arrangement, the deposit substrate originally needed for the first sensor 102 can be saved. Not only this arrangement will reduce the overall thickness of the touch-screen display device, but also will reduce the manufacturing cost thereof.

It should be pointed out that according to the second embodiment of the present invention, the touch-screen display device further includes a flexible printed circuit board 601 and a second flexible printed circuit board 602. Both the first and second flexible printed circuit boards 601, 602 have one end interconnected to a motherboard 602 for getting power supply. The first sensor 102 is interconnected to the other end of the first flexible printed circuit board 601, and the common electrode 205 is interconnected to the other end of the second end of the second flexible printed circuit board 602. By this arrangement, the motherboard 603 is further interconnected to a driving chip (not shown in the drawings) arranged within the thin film transistor array substrate 203 of the liquid crystal display module 20 to as to provide driving voltage to the liquid crystal display module 20.

In addition, the motherboard 603 is further interconnected to a driving chip (not shown in the drawings) arranged within the thin film transistor array substrate 203 of the liquid crystal display module 20, and further interconnected to the common electrode 205 so to as to provide driving voltage to the liquid crystal display module 20.

In addition, in assembling, the touch-screen panel 10 and the liquid crystal display module 20 can be configured together with an adhesive layer (not shown in Figures). However, the present invention will not be limited thereto.

In summary, according to the embodiment of the present invention, the touch-screen display device utilizes a polarized film of a liquid crystal display module as a deposit substrate of a sensor so as to reduce a thickness of the touch-screen device as well as the manufacturing cost.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A touch-screen display device, including a liquid crystal display module, a first polarized film, a first sensor and a second sensor, wherein the first polarized film is disposed onto the liquid crystal display module, and the second polarized sensor is disposed onto the first polarized film, wherein the first sensor is dielectrically disposed onto the second sensor.

2. The touch-screen display device as recited in claim 1, wherein the first sensor is a touch-sensing electrode, and the second sensor is touch-sensing driving electrode.

3. The touch-screen display device as recited in claim 1, further including an insulative layer arranged between the first sensor and a second sensor.

4. The touch-screen display device as recited in claim 2, further including an insulative layer arranged between the first sensor and a second sensor.

5. The touch-screen display device as recited in claim 1, further including a protective plate disposed onto the first sensor.

6. The touch-screen display device as recited in claim 2, further including a protective plate disposed onto the first sensor.

7. The touch-screen display device as recited in claim 1, further including flexible printed circuit board having one end interconnected to a motherboard, and having a dual-connection arrangement on the other end, wherein one of the dual-connection arrangement is interconnected to the first sensor, and the other of the dual-connection arrangement is connected to the second sensor.

8. The touch-screen display device as recited in claim 2, further including flexible printed circuit board having one end interconnected to a motherboard, and having a dual-connection arrangement on the other end, wherein one of the dual-connection arrangement is interconnected to the first sensor, and the other of the dual-connection arrangement is connected to the second sensor.

9. A touch-screen display device, including a liquid crystal display module, a first polarized film, a first sensor, wherein the first polarized film is disposed onto the liquid crystal display module, and the first sensor is dielectrically disposed onto the first polarized film.

10. The touch-screen display device as recited in claim 9, wherein the liquid crystal display module includes a common electrode, a backlight module, a thin film transistor array substrate, a liquid crystal layer, and a color filter substrate, wherein the color filter is disposed onto the backlight module, and the thin film transistor array substrate is disposed under the first polarized film and above the color film substrate, the liquid crystal layer being arranged between the thin film transistor array substrate and the color filter substrate, and the common electrode being arranged between the liquid crystal layer and the thin film transistor array substrate.

11. The touch-screen display device as recited in claim 10, wherein the common electrode is served as a displaying circuit for operation during the display stage when an image is displayed onto the touch-screen display device, and wherein the common electrode is served as a touch-sensing operational circuit during the touch-sensing stage.

12. The touch-screen display device as recited in claim 9, further including a protective plate which is disposed onto the first sensor.

13. The touch-screen display device as recited in claim 10, further including a protective plate which is disposed onto the first sensor.

14. The touch-screen display device as recited in claim 9, further including flexible printed circuit board having one end interconnected to a motherboard, and having a dual-connection arrangement on the other end, wherein one of the dual-connection arrangement is interconnected to the first sensor, and the other of the dual-connection arrangement is connected to the second sensor.

15. The touch-screen display device as recited in claim 10, further including flexible printed circuit board having one end interconnected to a motherboard, and having a dual-connection arrangement on the other end, wherein one of the dual-connection arrangement is interconnected to the first sensor, and the other of the dual-connection arrangement is connected to the second sensor.
